(19) United States
(12) Patent Application Publication
(10) Pub. No.: US 2014/0025419 A1
(43) Pub. Date: Jan. 23, 2014

(54) SYSTEM AND METHOD TO UPDATE AND ACCESS ASSET INFORMATION

(71) Applicant: General Electric Company, Schenectady, NY (US)

(72) Inventors: Michael ROSS, Hiram, GA (US); Paul DAVIS, Powder Springs, GA (US); Neil Linton, Atlanta, GA (US)

(21) Appl. No.: 13/940,441

(22) Filed: Jul. 12, 2013

Related U.S. Application Data
(60) Provisional application No. 61/674,618, filed on Jul. 23, 2012.

(51) Int. Cl. G06Q 10/06

(52) U.S. Cl. CPC G06Q 10/06313
USPC 705/7.23

(57) ABSTRACT

Systems and methods provide an update of asset information from disparate sources to an asset record that may be accessed by a computer-based application. Embodiments of the invention provide a controller operable to facilitate the timely updating of asset information for an asset to a comprehensive asset record corresponding to the asset as one or more pieces of the asset information, distributed across a plurality of data sources, changes in real time.

This U.S. patent application claims priority to pending provisional U.S. patent application Ser. No. 61/674,618 filed on Jul. 23, 2012 which is incorporated herein by reference in its entirety.

### BACKGROUND

1. Technical Field

The subject matter disclosed herein relates to methods and systems providing timely updates of asset information and ready access to the updated asset information.

2. Discussion of Art

A railroad yard, a shipping port, a warehouse, or a rental car parking lot may have assets (e.g., rail cars, ships, products, automobiles) located throughout which are to be managed in various ways (e.g., moved, loaded, stacked, linked, assigned, rented). An asset may have information associated with it that is distributed across many files in a database of, for example, a transportation management system (TMS). Pieces of the asset information may get updated in the database in an unpredictable manner, making it difficult to know when new information is available. It may be desirable to have a system that provides comprehensive, updated asset information in real time (e.g., in a timely manner) from a data access source.

3. Brief Description

Systems and methods for providing timely updates of asset information are disclosed. Embodiments of the invention provide a real time snapshot software application (RTSA) configured to update asset information in real time as asset information changes, and make the updated asset information available to other applications.

In one embodiment, a controller is provided that is operable to route asset information for an asset to an asset record in response to at least a portion of the asset information changing from a first value to a second, different value. The asset information is obtained from a plurality of data sources and the asset record represents a status of the asset at the time of the change from the first value to the second value.

In one embodiment, a system is provided that includes a controller as discussed above, and at least one asset database system distributed across a plurality of database files which includes the asset information for a plurality of assets, and that is operable to communicate with the controller.

In one embodiment, a system is provided that includes a plurality of assets configured to provide asset information. The system also includes an asset database system configured to receive the asset information and store the asset information in a distributed manner across a plurality of database files. The asset database system is operable to generate a trigger event when one or more pieces of asset information corresponding to an asset changes within the asset database system. The system further includes a controller configured to communicate with the asset database system. The controller is operable to update a determined set of fields of an asset record corresponding to the asset by pulling asset information corresponding to the asset from one or more database files of at least the asset database system into the asset record in response to sensing the trigger event.

In one embodiment, a method is provided that includes generating a trigger event in response to receiving and storing one or more changed pieces of asset information for an asset in a database system. The method also includes outputting asset identification information associated with the asset from the database system to a trigger queue in response to the trigger event, reading the asset identification information from the trigger queue, and updating a record of comprehensive asset information corresponding to the asset by pulling asset information corresponding to the asset from at least the database system based on the asset identification information.

### BRIEF DESCRIPTION OF THE DRAWINGS

Reference is made to the accompanying drawings in which particular embodiments of the invention are illustrated as described in more detail in the description below, in which:

FIG. 1 is a schematic block diagram of an exemplary embodiment of a system to gather updated asset information in real time from disparate sources as the asset information changes, and make the updated asset information available to other applications in a record;

FIG. 2A illustrates a schematic diagram of an exemplary embodiment of an asset database of the system of FIG. 1;

FIG. 2B illustrates a schematic diagram of an exemplary embodiment of an asset record file of the system of FIG. 1;

FIG. 3 illustrates a schematic block diagram of an exemplary embodiment of the system of FIG. 1 wherein the controller of FIG. 1 is configured as an asset management controller (AMC) and the asset database system of FIG. 1 is configured as a transportation management system (TMS);

FIG. 4 illustrates a functional block diagram of an exemplary embodiment of the system of FIG. 3;

FIG. 5 illustrates a flowchart of an exemplary embodiment of a method to update a record of comprehensive asset information for an asset using the system of FIG. 3; and

FIG. 6 illustrates an exemplary embodiment of a screen shot of a map view of an asset zone provided by the system of FIG. 3 which is updated in accordance with the method of FIG. 5.

### DETAILED DESCRIPTION

Embodiments of the invention relate to methods and systems providing for the timely updating of asset information from disparate sources to an asset record that may be accessed by a computer-based application.

The terms “container” and “trailer” refer to a storage medium configured to hold products, goods, or other shippable materials. The term “asset zone” refers to a location, site, area, or facility where assets are managed. The managing of assets may include, for example, moving, loading, stacking, linking, assigning, renting, and shipping the assets. The term “asset” refers generally to anything that may be managed in an asset zone. Examples of assets include, but are not limited to, locomotives, rail cars in a rail yard, containers/trailers in a rail yard, products in a warehouse, ships in a shipping port, mining equipment at a mining site, and rental cars in a rental car lot.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. The form of software depends on, for example, requirements of a desired application, the environment it runs on, and/or the desires of a designer/programmer or the like.

“Computer” or “processor” or “processing element” or “computer device” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. “Controller”, as used herein, refers to a system that includes the logic circuitry, memory, and/or processing devices and associated software, modules or programs. The terms “signal”, “data”, and “information” may be used interchangeably herein and may refer to digital or analog forms. The terms “configure”, “stack”, and “build” may be used interchangeably herein when referring to virtually or actually creating a profile of containers/trailers on cars or vessels of a train.

A rail vehicle consist is a group of rail vehicles that are mechanically linked together to travel along a track. A train is one example of a rail vehicle consist. Another example is a set of mining ore carts. A vehicle consist, more generally, is a group of vehicles that are mechanically linked together to travel along a route. A powered vehicle consist refers to the interaction of two or more powered vehicles that are mechanically linked together, as may be the case for a locomotive consist (providing multiple powered vehicles to move a train of otherwise unpowered vehicles). Although trains are often referred to herein, certain embodiments are more generally applicable to rail vehicle consists or other vehicle consists.

The term “real time” as used herein may mean “in a timely manner”, or refer to steps or actions immediately taken in response to some event. For example, actions may be taken to update asset information in an asset record immediately following a change in asset information in a database file. The term “update”, and its related forms, as used herein may refer to the replacement of something with something more recent (e.g., the replacement of asset data with more recent asset data). The term “comprehensive”, and its related forms, as used herein may refer to a complete set or an entire thing, or a largely complete set or most of something (e.g., a complete set of available data or information for an asset, or most of an asset record). The term “cloud-based system” as used herein refers to a system where at least a portion of the system (e.g., file storage) is located remotely and may be accessed via a computer network.

The system and methods described herein may be discussed in the context of a rail yard or terminal of a railroad with rail cars and/or containers/trailers as the assets. However, embodiments of the invention may apply equally well to other asset zones such as, for example, a shipping port, a warehouse, or a rental car parking lot, along with their corresponding assets.

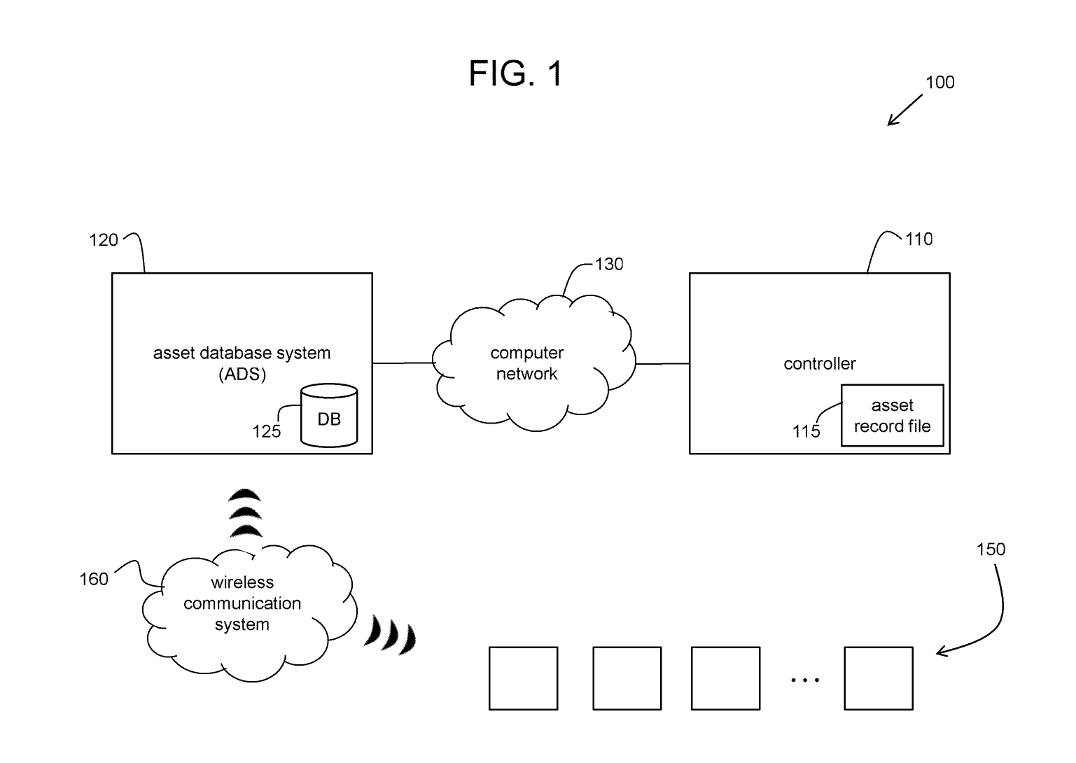

FIG. 1 is a schematic block diagram of an exemplary embodiment of a system 100 to gather updated asset information in real time from disparate sources as the asset information changes, and make the updated asset information available to other applications in a record. The system 100 includes a controller 110 having at least one asset record file 115. The asset record file 115 contains information on a plurality of assets which is kept up-to-date by the controller 110. In accordance with an embodiment, all asset information for an asset is recorded in an asset record for that asset, forming a comprehensive record of asset information. As a result, an application having access to the asset records may obtain all of the available information for an asset from the corresponding asset record.

The system also includes an asset database system (ADS) 120 having at least one database (DB) 125. The database 125 contains information on a plurality of assets, where the asset information is distributed across a plurality of files in the database 125. For example, the ADS 120 may be in the form of a transportation management system in accordance with an embodiment, and the asset information may be, at least in part, waybill information that is configured in a waybill structure across files of the database 125.

In accordance with an embodiment, the ADS 120 obtains asset information from a plurality of assets 150 via a wireless communication system 160 configured to communicate the asset information from the plurality of assets 150 to the ADS 120. The plurality of assets may include locomotives, mining equipment, construction equipment, rail cars, marine vessels, or automobiles, for example. The wireless communication system 160 may be a radio frequency communication system. Other types of wireless communication systems are possible as well, in accordance with various embodiments.

In accordance with an embodiment, the controller 110 and the ADS 120 are configured to communicate with each other through, for example, a communication network 130 (e.g., a computer network). The communication network may include one or more server computers, for example. Alternatively, the controller 110 and the ADS 120 may communicate directly with each other (i.e., not through a computer network), for example, through wired or wireless means. The controller 110 is operable to access asset information from the ADS 120 to update a record of the asset record file 115.

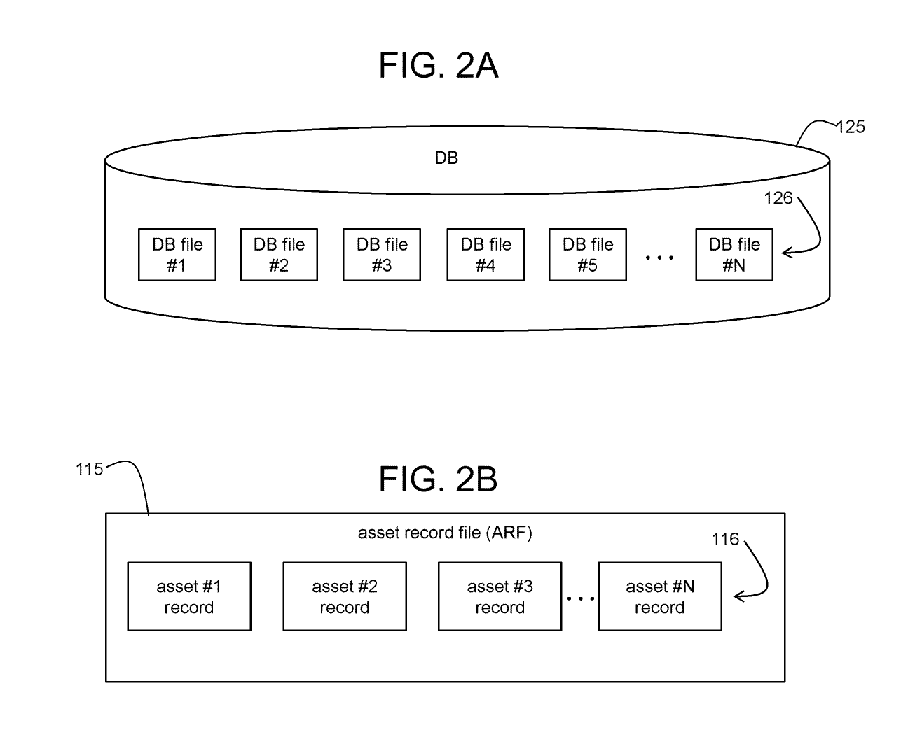

FIG. 2A illustrates a schematic diagram of an exemplary embodiment of an asset database 125 of the system 100 of FIG. 1. The database 125 stores and is distributed across a plurality of database files 126, where information for an asset may be distributed across many of the plurality of database files 126. For example, DB file #2 may store asset maintenance information for a plurality of assets, and DB file #3 may store asset billing information for the plurality of assets. The other database files may store other types of information for the same plurality of assets, where each database file corresponds to a particular type of asset information. As a result, all of the asset information for any one asset cannot be obtained from a single database file (single data source) since the asset information is distributed across many database files. In accordance with an embodiment, at least a portion of the plurality of database files may be stored in a cloud-based system.

Embodiments of the invention provide for the gathering of asset information for a particular asset such that the gathered asset information may be presented in an asset record. Therefore, an application needing access to the asset information for an asset can obtain the asset information from an asset record, instead of having to, for example, search many files across the entire database 125.

FIG. 2B illustrates a schematic diagram of an exemplary embodiment of an asset record file (ARF) 115 of the system 100 of FIG. 1. The asset record file 115 contains one unique asset record 116 of asset information for each particular asset in inventory. An asset record may have a determined set of fields that may be updated by the controller. For example, in a rail yard environment where the assets are rail cars, each asset record 116 may contain a comprehensive set of asset information for a unique rail car for the current inventory that is on-line in the rail yard. Each rail car asset record 116 may contain one-hundred data fields, for example, where the data to populate the one-hundred data fields is distributed across the database files of the asset database system 120.

Again, embodiments of the invention gather asset information for an asset from across many files in the ADS 120 and populate the data fields of the corresponding asset record 115 with the asset information. In this manner, an application needing access to the asset information for a particular asset can obtain the asset information from an asset record, instead of having to, for example, search many files across the entire database 125. The gathering and updating of the asset information for an asset is accomplished in real time, in accordance with various embodiments, such that the most up-to-date information for an asset is always available in that asset's asset record.

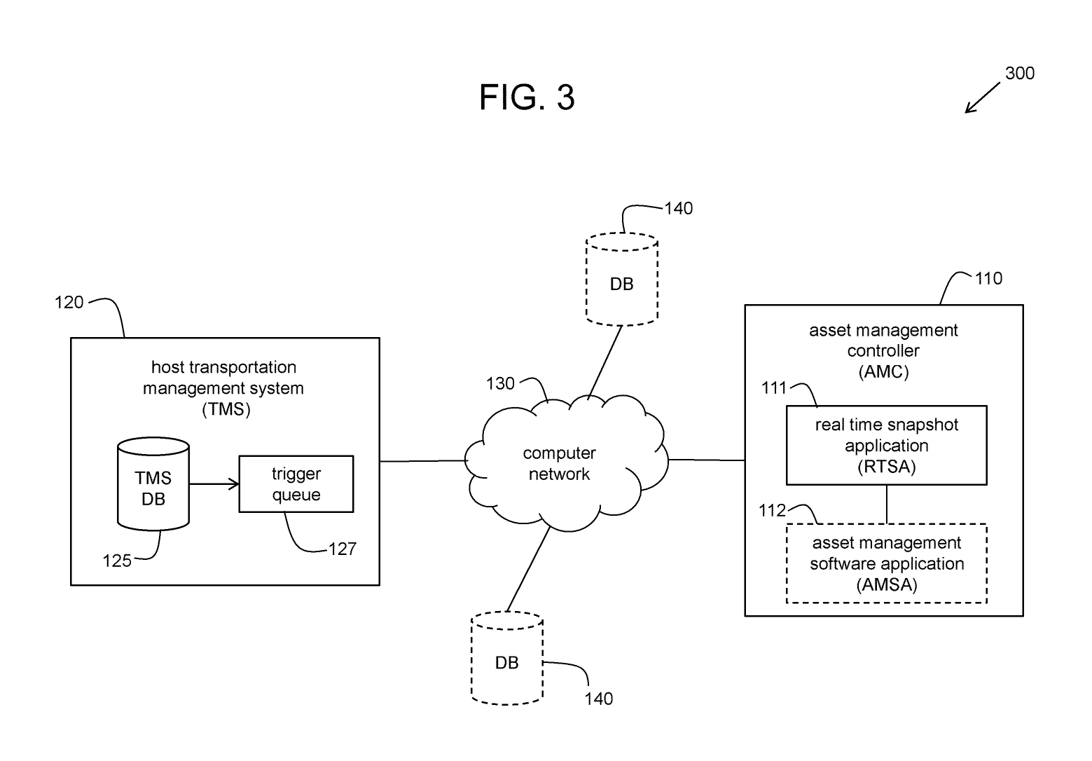

FIG. 3 illustrates a schematic block diagram of an exemplary embodiment of a system 300 that is similar to the system 100 of FIG. 1, but wherein the controller 110 is configured as an asset management controller (AMC) and the asset database system 120 is configured as a transportation management system (TMS). The system 300 includes a computer network 130 facilitating operable communication between the TMS 120 and the AMC 110. The system 300 may optionally include one or more additional databases 140. In accordance with an embodiment, the TMS database 125 is part of the transportation management system 120 and the database(s) 140 is a database for an accounts receivable and/or an accounts payable system.

The TMS 120 may be configured to manage various aspects (e.g., scheduling, tracking, way billing, revenue accounting) of a larger transportation system such as, for example, an entire railroad. Therefore, the TMS 120 may communicate with a plurality of asset management controllers 110 at a plurality of railroad terminals (asset zones) of the railroad. The TMS 120 includes a TMS database 125 and a trigger queue 127. The trigger queue 127 is a data structure that uses computer memory to record trigger events generated by the TMS 120. The AMC 110 hosts a real time snapshot application (RTSA) 111 and, optionally, an asset management software application (AMSA) that operatively communicates with the RTSA 111. The RTSA 111 is a software application that is operable to execute on the AMC 110. The RTSA 111 operates to update asset records 116 of the asset file 115 on the AMC 110 as is described in detail later herein.

The AMSA 112 may be one of many software applications that are configured to access and read asset records 116 from the RTSA 111. For example, in accordance with an embodiment, the AMC 110 is implemented as a server computer running the AMSA 112. The AMC 110, running the AMSA 112, manages assets within an asset zone (e.g., the assignment, loading, and movement of assets within a rail yard) and provides graphical mapping that allows visualization of the asset zone by a user on a display screen of a personal computer, for example. The RTSA 111, also running on the AMC 110, provides access of up-to-date asset information to the AMSA 112 as described herein.

In accordance with various other embodiments of the present invention, the system 300 may be configured in various other ways. For example, the asset management controller may be co-located with or be implemented on a same server computer as the TMS. As another example, the asset management controller may be hosted at a third party site (e.g., a provider of the AMSA) as a software-as-a-service (SaaS) configuration. Other configurations are possible as well, in accordance with various other embodiments of the present invention.

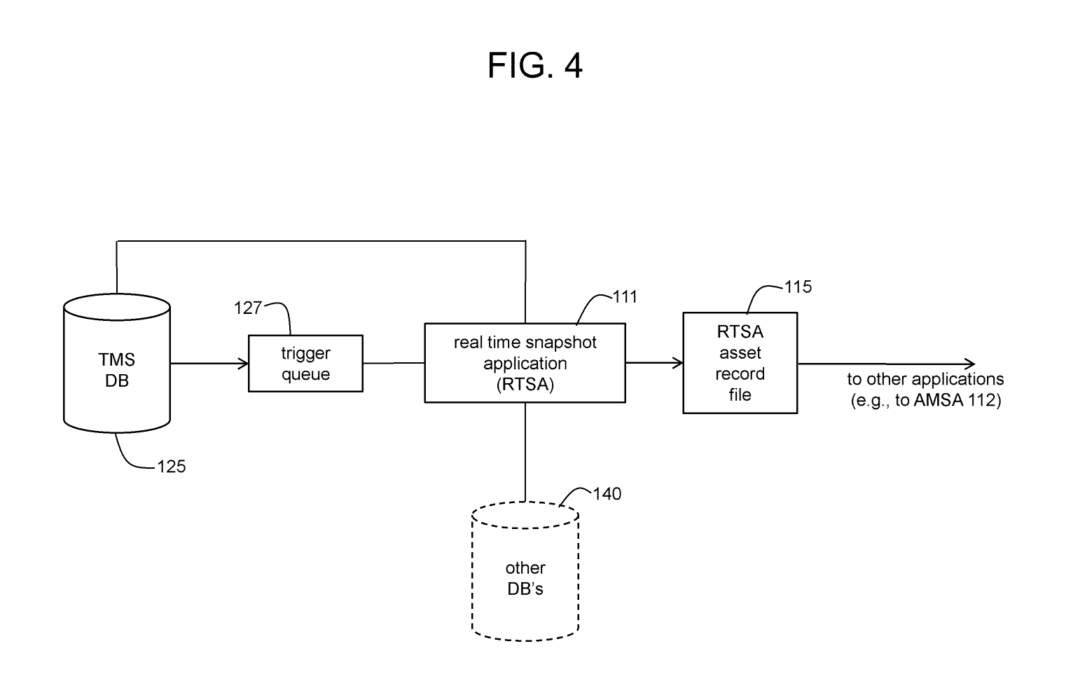

FIG. 4 illustrates a functional block diagram of an exemplary embodiment of the system 300 of FIG. 3. In accordance with an embodiment, various triggers are set up in the TMS database system 120 such that, when a determined piece or field of information for an asset changes or is updated (e.g., changes from a first value to a second, different value) within a file 126 of the TMS database 125, a trigger event is generated by the TMS 120. A trigger event may include, but is not limited to, setting a data flag, outputting a message, or outputting a code.

When the trigger event is generated, the TMS 120 outputs asset identification information associated with the asset to the trigger queue 127. The RTSA 111, monitoring the trigger queue 127, senses or determines a change in the trigger queue 127 and reads the asset identification information in the trigger queue 127. In accordance with an embodiment, the asset identification information may include a primary key for the asset having a unique control number, an asset initial (e.g., a rail car initial), and/or an asset number (e.g., a rail car number). Other identifying information (e.g., a waybill code) may be used depending on application specific parameters. Furthermore, in accordance with an embodiment, additional information such as the type or category of data that has changed may be output to the trigger queue 127 as well.

The RTSA 111 then uses the asset identification information to gather asset information corresponding to the asset from the various database files 126 of the TMS DB 125, and possibly from files of other databases 140 as well. In this manner, in response to the trigger event, all available asset information (or some subset thereof), including the piece of asset information that changed and triggered the trigger event, may be gathered by the RTSA 111 and updated into the fields of the corresponding asset record 116 for the asset. The RTSA 111 does not have to “know” which particular piece of asset information actually changed and caused the trigger event. In accordance with an embodiment, the RTSA 111 operates in the background. As a result, up-to-date asset information is always available to other applications (e.g., to the AMSA 112) in an asset record 116 for any given asset. Asset information may include waybill information, asset location information, asset content, asset weight, and/or other types of asset information, in accordance with various embodiments.

In accordance with an embodiment, a subset of data fields of the plurality of database files may be periodically queried by the database system and, if there is no change in the values of the subset of data fields, a trigger event is not initiated. Furthermore, if one or more data sources of the database system are unavailable to provide updated asset information, the comprehensive asset information in an asset record may be annotated to indicate the inability to update the asset record.

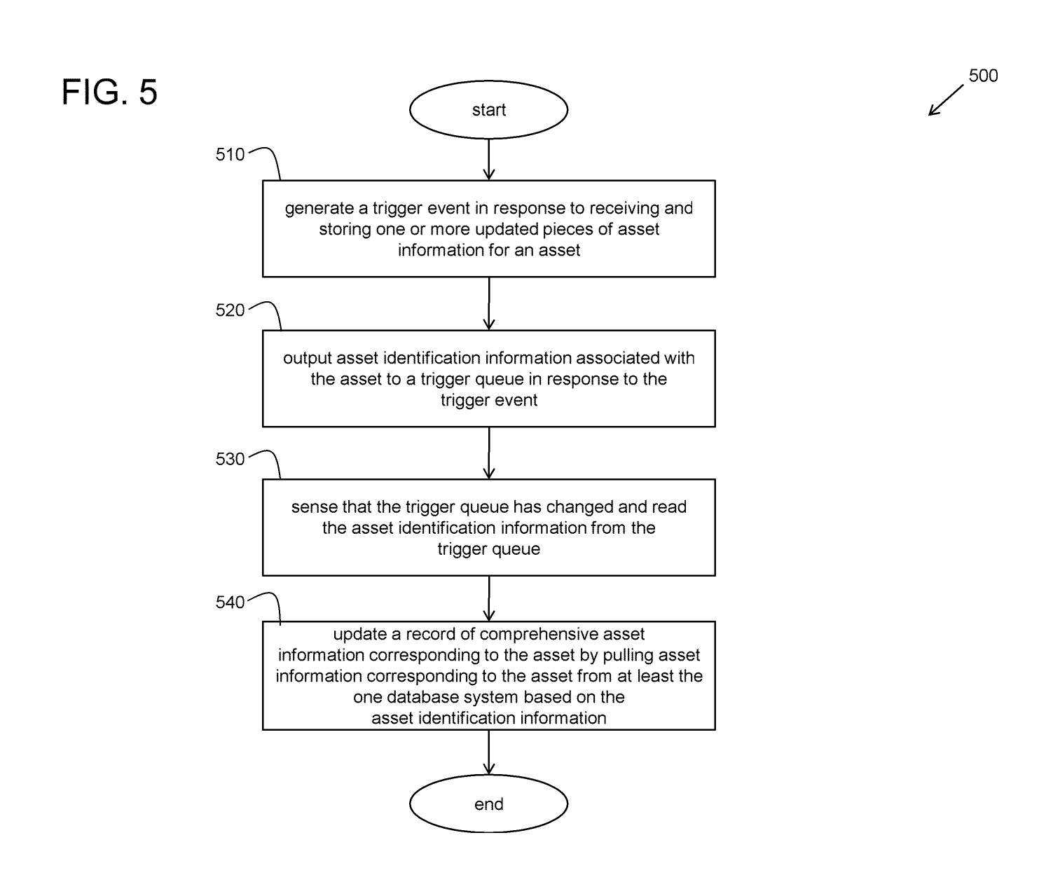

FIG. 5 illustrates a flowchart of an exemplary embodiment of a method 500 to update a record 116 of comprehensive asset information for an asset using the system 300 of FIG. 3, in accordance with the functional block diagram of FIG. 4. In step 510, a database system generates a trigger event in response to receiving and storing one or more updated pieces of asset information for an asset. In step 520, the database system outputs asset identification information associated with the asset to a trigger queue in response to the trigger event. In step 530, a controller senses that the trigger queue has changed and reads the asset identification information from the trigger queue. In step 540, the controller updates a record of comprehensive asset information corresponding to the asset by pulling asset information corresponding to the asset from at least the database system based on the asset identification information.

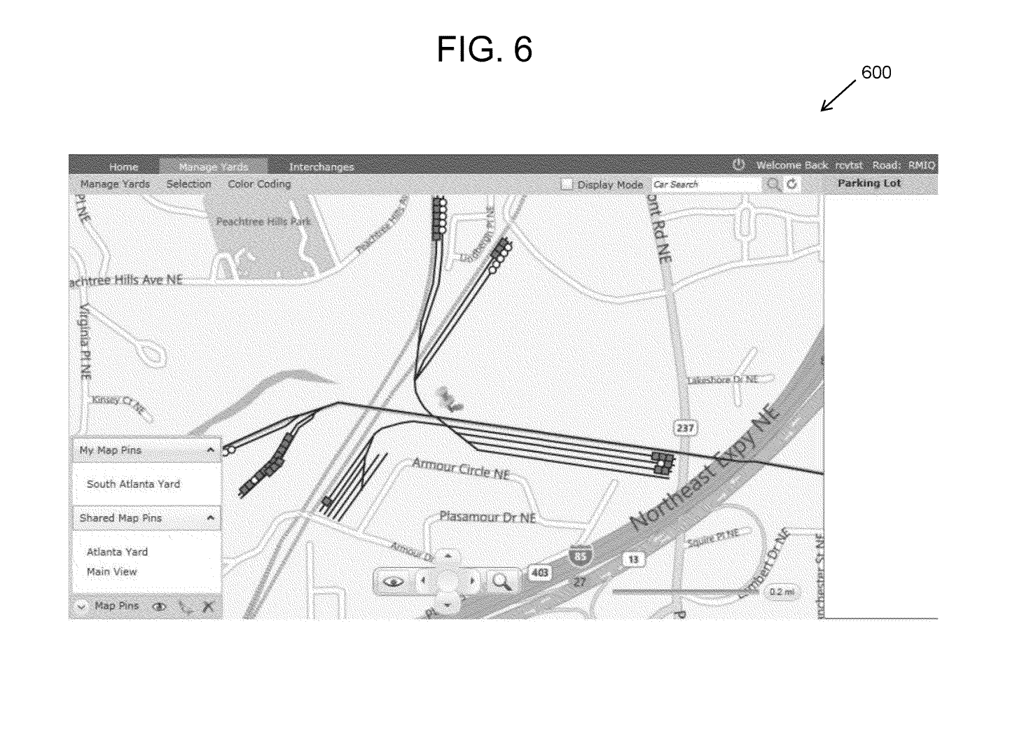

As an example, FIG. 6 illustrates an exemplary embodiment of a screen shot 600 of a map view of an asset zone provided by the system 300 of FIG. 3 which may have information updated in accordance with the method 500 of FIG. 5. The map view is a graphic representation of a rail yard and tracks overlaid on a map of the area. In accordance with an embodiment, a refresh icon is provided in the map view, allowing a user to update the view to show the current inventory (assets) in the yard as overlaid icons.

The updated asset information is received by the controller 110 from the TMS 120, in accordance with methods described herein, and processed by the AMSA 112 to refresh the view on a display screen of the user computer (not shown). Rail car information may be presented in visual form as, for example, icons on a map overlay of the yard or zone. In accordance with an embodiment, the icons provide cues and clues about the status and location of a rail car, locomotive, or container/trailer which may include an asset identification (ID) code, a cargo type, a destination, an origination, a container type, asset health, equipment status, maintenance status, or load status. Also, in accordance with an embodiment, a user may hover a cursor over and asset icon to display and view other asset information (e.g., in textual form) associated with that asset. For example, changed asset information may be selectively displayed to the user. Furthermore, a user may be alerted that the asset information has changed. For example, a rule set may be applied that indicates an imminence, severity, or magnitude of the changed of the asset information. As a result, using the systems and methods described herein, up-to-date asset information can be provided to applications and users to facilitate the management of assets within an asset zone.

In one embodiment, a controller is provided that is operable to route asset information for an asset to an asset record in response to at least a portion of the asset information changing from a first value to a second, different value. The asset information is obtained from a plurality of data sources and the asset record represents a status of the asset at the time of the change from the first value to the second value. The controller may be operable to respond to a query of a current status of the asset by referring to the asset record of the asset, and not to the plurality of data sources. The controller may be operable to route asset information for a plurality of assets to a corresponding asset record for each asset of the plurality of assets when at least a portion of the asset information changes for an asset, wherein the asset information for each asset is obtained from the plurality of data sources.

In one embodiment, a system is provided that includes a controller as discussed above, and at least one asset database system distributed across a plurality of database files which includes the asset information for a plurality of assets, and that is operable to communicate with the controller. The asset database system may include a transportation management system (TMS) and the controller may include an asset management controller (AMC) having an asset management software application (AMSA). The controller may further be operable to determine when one or more determined pieces of asset information for an asset changes in the asset database system, and to comprehensively update an asset record corresponding to the asset by pulling asset information corresponding to the asset from at least the asset database system. The system may further include a communication network configured to provide communications between the asset database system and the controller. At least a portion of the plurality of database files may be stored in a cloud-based system, and the communication network may include one or more server computers.

In one embodiment, a system is provided that includes a plurality of assets configured to provide asset information. The system also includes an asset database system configured to receive the asset information and store the asset information in a distributed manner across a plurality of database files. The asset database system is operable to generate a trigger event when one or more pieces of asset information corresponding to an asset changes within the asset database system. The system further includes a controller configured to communicate with the asset database system. The controller is operable to update a determined set of fields of an asset record corresponding to the asset by pulling asset information corresponding to the asset from one or more database files of at least the asset database system into the asset record in response to sensing the trigger event. The system may also include a wireless communication system configured to communicate the asset information from the plurality of assets to the asset database system. The plurality of assets may include one or more locomotives, mining equipment, construction equipment, rail cars, marine vessels, or automobiles. The trigger event may include one or more of setting a data flag, outputting a message, or outputting a code. A subset of data fields of the database files may be queried periodically and, if there is no change in values of the subset of data fields of the database files, no trigger event is initiated.

In one embodiment, a method is provided that includes generating a trigger event in response to receiving and storing one or more changed pieces of asset information for an asset in a database system. The method also includes outputting asset identification information associated with the asset from the database system to a trigger queue in response to the trigger event, reading the asset identification information from the trigger queue, and updating a record of comprehensive asset information corresponding to the asset by pulling asset information corresponding to the asset from at least the database system based on the asset identification information. The method may also include accessing and reading the updated record of comprehensive asset information and/or displaying a representation of the asset in an asset zone showing at least a portion of the asset information of the comprehensive record of asset information. The method may include selectively displaying the changed asset information of the asset to a user and/or alerting a user that the asset information has changed. The alerting may include applying a rule set that indicates an imminence or severity or magnitude of the change of the asset information. In accordance with an embodiment, if one or more data sources of the database system are unavailable to provide updated asset information, the method may further include annotating the comprehensive asset information to indicate the unavailability of the updating of the record.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A controller that is operable to route first asset information for a first asset to a first asset record in response to at least a portion of the first asset information changing from a first value to a second, different value, wherein the first asset information is obtained from a plurality of data sources and the first asset record represents a status of the first asset at the time of the change from the first value to the second value.

2. The controller of claim 1, wherein the controller is operable to respond to a query of a current status of the first asset by referring to the first asset record of the first asset, and not to the plurality of data sources.

3. The controller of claim 1, wherein the controller is operable, for each second asset of a plurality of second assets, to route respective second asset information for the second asset to a corresponding second asset record for the second asset when at least a portion of the second asset information changes for the second asset, wherein the second asset information for the second asset is obtained from the plurality of data sources.

4. A system, comprising:
the controller defined in claim 1; and
at least one asset database system distributed across a plurality of database files which includes asset information for a plurality of assets, and that is operable to communicate with the controller, wherein the plurality of assets includes a first asset and the asset information for the plurality of assets includes first asset information.

5. The system of claim 4, wherein the asset database system includes a transportation management system and the controller includes an asset management controller having an asset management software application.

6. The system of claim 4, wherein the controller is further operable to determine when one or more determined pieces of the asset information for one of the plurality of assets changes in the asset database system, and to comprehensively update an asset record corresponding to said one of the plurality of assets by pulling the asset information for said one of the plurality of assets from at least the asset database system.

7. The system of claim 4, further comprising a communication network configured to provide communications between the asset database system and the controller.

8. The system of claim 7, wherein at least a portion of the plurality of database files are stored in a cloud-based system and the communication network comprises one or more server computers.

9. A system, comprising:
an asset database system configured to receive asset information provided by a plurality of assets and to store the asset information in a distributed manner across a plurality of database files, and the asset database system is operable to generate a trigger event when one or more pieces of the asset information corresponding to a first asset of the plurality of assets changes within the asset database system; and
a controller configured to communicate with the asset database system, wherein the controller is operable to update a determined set of fields of an asset record corresponding to the first asset by pulling the asset information corresponding to the first asset from one or more of the database files of at least the asset database system into the asset record in response to sensing the trigger event.

10. The system of claim 9, further comprising a wireless communication system configured to communicate the asset information from the plurality of assets to the asset database system.

11. The system of claim 10, wherein the plurality of assets include one or more locomotives, mining equipment, construction equipment, rail cars, marine vessels, or automobiles.

12. The system of claim 9, wherein the trigger event comprises one or more of setting a data flag, outputting a message, or outputting a code.

13. The system of claim 9, wherein the asset database system is configured to periodically query a subset of data fields of the database files, and when there is no change in values of the subset of data fields of the database files, the asset database system is configured not to generate the trigger event.

14. A method comprising:
generating a trigger event in response to receiving and storing one or more changed pieces of asset information for an asset in a database system;
outputting asset identification information associated with the asset from the database system to a trigger queue in response to the trigger event;
reading the asset identification information from the trigger queue; and
updating a record of comprehensive asset information corresponding to the asset by pulling asset information corresponding to the asset from at least the database system based on the asset identification information.

15. The method of claim 14, further comprising accessing and reading the record of comprehensive asset information that is updated.

16. The method of claim 14, further comprising displaying a representation of the asset in an asset zone showing at least a portion of the asset information of the comprehensive record of asset information.

17. The method of claim 14, further comprising selectively displaying the one or more changed pieces of asset information of the asset to a user.

18. The method of claim 14, further comprising alerting a user that the one or more changed pieces of asset information have changed.

19. The method of claim 18, wherein the alerting comprises applying a rule set that indicates at least one of an imminence or severity or magnitude of the change of the one or more pieces of asset information.

20. The method of claim 14, wherein if one or more data sources of the database system are unavailable to provide updated asset information, the method further comprises annotating the comprehensive asset information to indicate the unavailability of the updating of the record.
